(19) United States
(12) Patent Application Publication
(10) Pub. No.: US 2022/0164682 A1
(43) Pub. Date: May 26, 2022

(54) TRANSACTION RESPONSE TIME ESTIMATION

(71) Applicant: INTERNATIONAL BUSINESS MACHINES CORPORATION, Armonk, NY (US)

(72) Inventors: Al Chakra, Apex, NC (US); MING QIAO SHANG GUAN, Beijing (CN); Hong Tao Li, Beijing (CN); Mai Zeng, Beijing (CN); Grant S. Mericle, Durham, NC (US); Jing BJ Ren, Beijing (CN); Xiao Chen Huang, Beijing (CN); Yu Mei Dai, Beijing (CN)

(21) Appl. No.: 17/102,830

(22) Filed: Nov. 24, 2020

(51) Int. Cl. G06N 5/04; G06N 20/00; G06Q 10/06

(52) U.S. Cl. CPC G06N 5/04; G06N 20/00; G06F 17/13; G06Q 10/06375; G06Q 10/067

(57) ABSTRACT

A method and system for predicting a response time for a workload prior to making a hardware upgrade to a computing system. Data related to operation of the system is collected. Then a workload model of a plurality of workloads and CPU utilization for the plurality of workloads and a transaction model for each transaction within a workload of the plurality of workloads are built. Next the process determines that a characteristic of at least one workload in the plurality of workloads will change due to the hardware upgrade. As a result of the change, a new workload model for the changed workload is built based on the changed characteristic, and the response time for the workload based on the new workload model is calculated.

### BACKGROUND

Aspects of the present disclosure relates system maintenance, more specifically to predicting the response time for new workloads following a hardware upgrade to the system.

Many customers are using mainframe computers to support their mission critical workloads. This is because of the reliability and performance of mainframe computers. About every 18 months there is a new generation of mainframe hardware made generally available to customers. Many customers decide to upgrade their systems to incorporate the new hardware to take advantage of the newer system's capabilities. Some customers will use this hardware upgrade to modify their hardware configurations and to make workload changes based on their business's dynamics in order to obtain better workload performance. However, bringing on new machines creates an issue that the customer needs to assess how the new machine and/or configurations will affect their workloads. Newer machines typically have enhancements in the processing capacity of the machine processers. This often results in the new machine having fewer processors for similar processing capacity as the existing hardware.

### SUMMARY

Embodiments of the present disclosure are directed to a system for predicting hardware upgrade impacts to workloads due to variables in configurations. The system includes a data collection module configured to collect data from the system prior to a hardware upgrade, a workload analysis module configured to analyze the data and build a workload model to determine a relationship between different types of workloads processed through the system, and a transaction analysis module configured to analyze a resource consumption of transactions within each workload. The system further includes a workload construct module configured to construct a new utilization model based on transactions within that workload and based on changes to transactions within the workload; and a response time estimation module configured to take input from a user and determine a response time based on CPU utilization.

Embodiments of the present disclosure are directed to a method for predicting a response time for a workload prior to making a hardware upgrade to a computing system. Data related to operation of the system is collected. Then a workload model of a plurality of workloads and CPU utilization for the plurality of workloads and a transaction model for each transaction within a workload of the plurality of workloads are built. Next the process determines that a characteristic of at least one workload in the plurality of workloads will change due to the hardware upgrade. As a result of the change, a new workload model for the changed workload is built based on the changed characteristic, and the response time for the workload based on the new workload model is calculated.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram illustrating components of a system for predicting hardware upgrade impacts due to variables in configurations, according to embodiments.

FIG. 2 is a flow diagram illustrating a process used to construct a new workload, according to embodiments.

FIG. 3 is a flow diagram of a process for predicting the response time of modifications resulting from a change in hardware configuration, according to embodiments.

FIG. 4 is a block diagram illustrating a computing system according to one embodiment.

FIG. 5 is a diagrammatic representation of an illustrative cloud computing environment.

FIG. 6 illustrates a set of functional abstraction layers provided by cloud computing environment according to one illustrative embodiment.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relates system maintenance, more specifically to predicting the response time for new workloads following a hardware upgrade to the system. While the present disclosure is not necessarily limited to such applications, various aspects of the disclosure may be appreciated through a discussion of various examples using this context.

Many customers are using mainframe computers to support their mission critical workloads. This is because of the reliability and performance of mainframe computers. About every 18 months there are new generations of mainframe hardware made generally available to customers. Many of these customers decide to upgrade their systems to incorporate the new hardware to take advantage of the newer system's capabilities. Some customers will use this hardware upgrade to modify their hardware and to make workload changes based on their business's dynamics in order to obtain better workload performance. However, bringing on new machines creates an issue that the customer needs to assess how the new machine and/or configurations will affect their workloads. Newer machines typically have enhancements in the processing capacity of the machine processers. This often results in the new machine having a different number of processors for similar processing capacity as the existing hardware.

By bringing on new hardware the customers may need to update their service level agreements to account for the new configurations impact on performance and pricing. One metric that is important to many users of mainframe systems is the response time for transaction. Specifically users who engage in online transactions are especially cognizant of the impacts to transaction times.

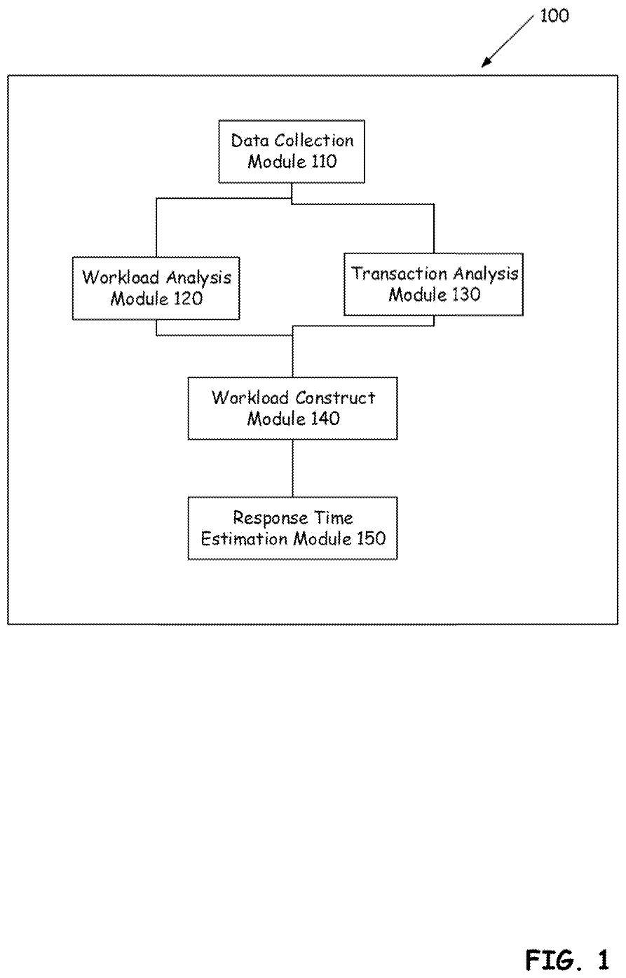

FIG. 1 is a block diagram illustrating components of a system 100 for predicting hardware upgrade impacts due to variables in configurations. System 100 includes a data collection module 110, a workload analysis module 120, a transaction analysis module 130, a workload construct module 140, and a response time estimation module 150.

The data collection module 110 is a component of the system that is configured to collect data from the system prior to any upgrade. In some embodiments, the data collection module 110 collects system management facility data (SMF), application and/or workload configuration data, and hardware configuration data. For the SMF data, the data collection module 110 collects data related to the CPU utility of each job being executed. For Application/workload configuration data, the data collection module 110 collects data related to workload priority and workload class. For the hardware configuration data, the data collection module 110 collects data such as the number of CPUs utilization and the number of instructions processed per second, e.g. MIPS. However, depending on the particular metrics that are desired to be measured, the data collection module 110 can collect more or different types of data related to the performance of the underlying system.

The workload analysis module 120 is a component of the system that is configured to analyze the data and build a model to determine the relationship between different types of workloads. In some embodiments the workload analysis module 120 determines the relationship based on a CPU utilization point of view. In some embodiments, the workload analysis module 120 can include a workload identification component and a workload model builder.

The workload identification module is a component of the workload analysis module 120 that is configured to identify the priority of different workloads and related CPU usage in the system. In some embodiments the workloads are marked into different priority classes. For example given the following workloads SYSTEM.SYSTEM, SYSTEM.SYSSTC, STCTASKS.STCOMEGA, STCTASKS. STCHI, DATABASE.*, ONLINES.CICSSTC, STCTASKS.STCMED, and STCTASKS.STCLOW the workload identification model can divide these workloads into 4 different priority classes. However, it should be noted that the number of priority classes can be any number of classes greater than 3. In this example, a priority class of 0 is given the highest priority and applied to base system consuming workloads. Thus, in this example SYSTEM. SYSTEM and SYSTEM.SYSSTC are marked as priority class 0. Moving through the remaining priority classes, where the lower the priority number the higher the priority is, STCTASKS.STCOMEGA and STCTASKS.STCHI are given priority class 1, DATABASE.* and ONLINES.CICSSTC are given priority class 2, and STCTASKS.STCMED & STCTASKS.STCLOW are given priority class 3.

The workload identification module then accumulates CPU usage for each priority class based upon time stamp. Table 1 below illustrates an example of CPU monitoring data as accumulated by the workload identification module. It should be noted that in table 1 the column “importance” corresponds to priority class.

TABLE 1

| | | | CPU | | Accum |
|---|---|---|---|---|---|
| Description | Priority | Importance | % | MPL | CPU % |
| SYSTEM.SYSTEM | 255 | 0 | 3.8% | 24.3 | 4% |
| SYSTEM.SYSSTC | 254 | 0 | 4.5% | 30.0 | 2% |
| STCTASKS.STCOMEGA | 58 | 1 | 7.3% | 2.0 | 16% |
| STCTASKS.STCHI | 56 | 1 | 0.1% | 3.0 | 16% |
| DATABASE.DBZSTC | 55 | 1 | 9.4% | 3.0 | 25% |
| DATABASE.DBZSTCB | 55 | 1 | 0.0% | 3.0 | 25% |
| TSO.TSO 1 | 50 | 2 | 0.0% | 0.0 | 25% |
| ONLINES.CICSSTC | 45 | 2 | 56.7% | 1.0 | 82% |
| STCTASKS.STCMED | 34 | 3 | 5.0% | 15.6 | 87% |
| STCTASKS.STCLOW | 23 | 4 | 0.8% | 7.2 | 28% |

The workload identification module passes the accumulated data for the various workloads in the system and passes this data to the workload model builder. The workload model builder is a component of the workload analysis module 120 that is configured to generate at least one workload relationship model based on the accumulated data. To build the model the workload model builder applies machine learning to the accumulated data to train and create the workload relationship model. In some embodiments the model is a linear regression model. However, other types of models can be used such as support vector machines, decision trees, Bayesian networks, etc. The workload model builder outputs n models (where n represents the number of priority classes) representing the different classes of priority versus the higher priority classes. That is:
M0—The relationship of Priority Class 0 versus all others
M1—The relationship of Priority Class 1 versus Priority Class 0
M2—The relationship of Priority Class 2 versus Priority Class 0+Priority Class 1 . . . .
Mn—he relationship of Priority Class n versus SUM(Priority Class 0, Priority Class 1, . . . Priority Class (n−1)

These workload relationship models are then provided to the response time estimation module 150 for further use.

The transaction analysis module 130 is a component of the system that is configured to analyze the resource consumption of transactions. The transaction analysis module 130 is, in some embodiments, further configured to build a model for each type of transaction. In some embodiments the transaction analysis module 130 includes a transaction identification module and a transaction model builder.

The transaction identification module is a component of the transaction analysis module 130 that is configured to identify each type of transaction. The transaction identification module is further configured to determine the amount of CPU utilization required by the transaction. This utilization can be measured in MIPS or in time. For each transaction, the transaction identification module takes the start time of the transaction and the CPU time for the transactions and computes the overall transaction per second (TPS) and the CPU percentage consumed for each type of transaction. Table 2 illustrates an example of the data that is used to compute the CPU utilization and the TPS. Table 3 shows the results of that computation by the transaction identification module.

TABLE 2

| Start Time | Transaction ID | CPU Time |
|---|---|---|
| 10:00 | Tran1 | 0.003 |
| 10:00 | Tran2 | 0.003 |
| 10:01 | Tran3 | 0.004 |
| 10:01 | Tran4 | 0.002 |
| . . . | . . . | . . . |

TABLE 3

| Transaction ID | CPU Utilization | TPS | Start Time |
|---|---|---|---|
| Tran1 | 2% | 100 | 10:00 |
| Tran2 | 2.1% | 200 | 10:00 |
| . . . | . . . | . . . | . . . |

The transaction model builder is a component of the transaction analysis module 130 that is configured to analyze the resource consumption for each type of transaction and build a model for each type of transaction. In one embodiment the model is a model of the millions of instructions per second (MIPS) consumed by each type of transaction versus the CPU utilization for each type of transaction. To generate the model the transaction model builder uses a machine learning algorithm with the transaction data to train and create the transaction model. In some embodiments the model is a linear regression model. However, other types of models can be used such as support vector machines, decision trees, Bayesian networks, etc. The transaction model builder outputs a transaction model for each type of transaction that was identified by the transaction analysis module 130.

The workload construct module 140 is a component of the system configured to construct a new base workload based on the transactions within that workload. The workload construct module 140 constructs the new base workload for the transaction when the characteristics of the workload changes. For example, the distribution of the types of transactions has changed within the workload. However, in some embodiments the workload construct module 140 creates a new base workload regardless if the characteristics of the transactions have changed.

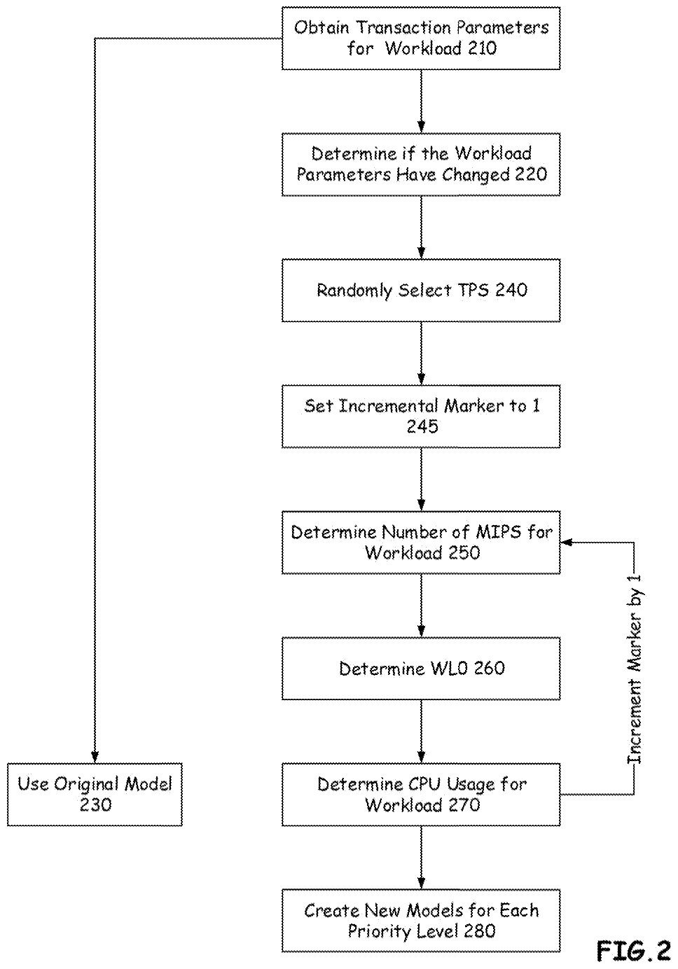

FIG. 2 is a flow diagram illustrating a process used by the workload construct module 140 to construct a new workload. The workload construct module 140 obtains a transaction parameter for the new workload. This is illustrated at step 210. The transaction parameter includes a transaction name and a number of transactions per second for the new workload. Next the workload construct module 140 determines if the proportion of the transactions for new workload are the same as for the previous version of the workload. This is illustrated at step 220. This information can be automatically calculated by the module, or can be manually input by an administrator of the system. If the proportions for the workload are the same, then the workload construct module 140 uses the workload models that were previously created for the workload by the workload analysis module 120. This is illustrated at step 230.

If the proportions for the workload are not the same, the workload construct module 140 proceeds to randomly select a list of a number of percentages of the transaction per second. This is illustrated at step 240. The workload construct module 140 generates a list of workloads for the transaction as a list of Z=[z1, z2, . . . zm]. Where z is the percentage of the transactions per second consumed by the particular transaction within the workload.

The workload construct module 140 sets an incremental marker initially to 1. This is illustrated at step 245. This initial incremental marker coincides with the first percentage in the list represented by Z.

For each workload that has had its proportion of transactions changed the workload construct module 140 determines the number of MIPS consumed by that workload. This is illustrated at step 250. The workload construct module 140 uses the MIPS per transaction, the transactions per second, and the percentage of TPS for the transaction represented by the q value associated with the incremental marker within the list Z to compute the total MIPS that the particular workload consumed. This is generated into a list of MIPS consumed for each workload analyzed.

Next the workload construct module 140 determines a relative workload consumption of the particular workload as against the highest priority workloads. This is illustrated at step 260. To obtain the MIPS consumed for WL0 for this particular transaction, the workload construct module 140 uses total number of MIPS consumed for the transaction and the model generated by workload model builder for the highest priority level M0. This value is added to the previously generated list of MIPS consumed for each workload under analysis.

The workload construct module 140 then determines the CPU usage for each workload. This is illustrated at step 270. To generate this list the workload construct module 140 takes the total number of MIPS that are available to the system for all transactions and MIPS consumed by the transaction, and determines a CPU utilization for the transaction. This information is added to a list of CPU_WL_Z for the system.

Once completed through steps 250-270, the workload construct module 140 increments the incremental marker to the next value. If the next value for the incremental marker is associated with a transaction in the list represented by Z then the workload construct module 140 repeats steps 250-270 for that transaction. Once all of the transactions within the list of Z have been analyzed, the workload construct module 140 proceeds to create new models for each priority level of workloads. This is illustrated at step 280. At this step the approach taken by the workload model builder and the transaction model builder is used to build these new models using the CPU_WL_Z list that was generated through the iterations of step 270.

The response time estimation module 150 is a component of the system that is configured to take input from users, such as customers, and determine the response time based on CPU utilization. In some embodiments the response time estimation module 150 assesses the trend in the response time. To determine the response time for a particular workload the estimation module uses a ratio of transactions, the number of CPUs and the MIPS. In some embodiments the response time estimation module 150 implements an impact factor Ft(c,u)=Q/S. To calculate the Q/S for a particular workload:

$$\frac{Q}{S} = \frac{\frac{{u}^{C}}{\text{?}}}{\frac{{u}^{C}}{\text{?}} + ( 1 - U ) \times \text{?} \frac{{u}^{n}}{n !}} \times \frac{1}{C \times ( 1 - U )} \\ \text{?} \text{indicates text missing or illegible when filed} \qquad Equation 1$$

where Ft is the impact factor, c is the number of CPU's present, u is the CPU utilization rate based on the generated models, Q is the queuing time, S is the service time, and U is the workload priority for the particular workload being analyzed. The module then calculates a low impact factor FtLow (c,u) for the particular workload as:

$$FtLow ( c , u ) = \frac{U}{Ul} * Ft ( c , u ) - \frac{Uh}{Ul} * Ft ( c , u ) \qquad Equation 2$$

Where Ul us the lowest priority workload and Uh is the sum of the workloads that are higher priority than the current workload priority U. With this information now available the response time for the workload is determined as:

ResptPria(c,u)=(1+FtLow(c,u))*S Equation 3

The response time for each of the workload priorities is then placed into a list that can be presented to the system administrator to determine the impact to their workloads caused by the new hardware configurations.

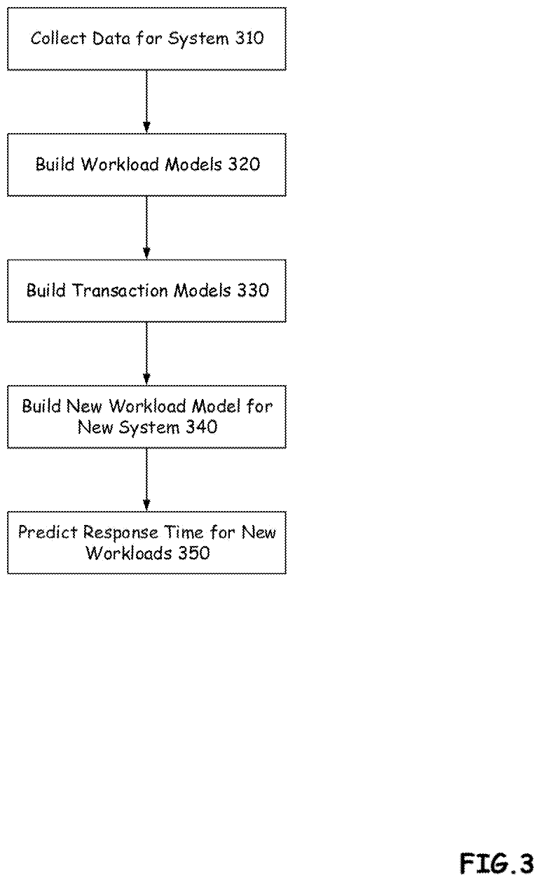

FIG. 3 is a flow diagram of a process for predicting the response time of modifications resulting from a change in hardware configuration. The process begins by collecting data from the system. This is illustrated at step 310. In some embodiments, the data collection module 110 collects system management facility data, application and/or workload configuration data, and hardware configuration data. However, depending on the particular metrics that are desired to be measured, more or different types of data related to the performance of the underlying system can be collected at this step.

Once the data has been collected and the data is analyzed, a model of various workloads and their CPU utilization is built. This is illustrated at step 320. In some embodiments the workload analysis model analyzes the data and builds a model to determine the relationship between different types of workloads. In some embodiments the workload analysis module 120 determines the relationship based on CPU utilization. The process further identifies the priority of different workloads and related CPU usage in the system. In some embodiments the workloads are placed into different priority classes. The accumulated data for the various workloads in the system are used to generate at least one workload relationship model.To build the model, machine learning is applied to the accumulated data to train and create a workload relationship model. In some embodiments the model is a linear regression model. However, other types of models can be used such as support vector machines, decision trees, Bayesian networks, etc. n models (where n represents the number of priority classes) representing the different classes of priority versus the higher priority classes is output for use in later analysis.

The resource consumption of the transactions within the workload are analyzed to build a model of each transaction. This is illustrated at step 330. In some embodiments the transaction analysis model analyzes the resource consumption and builds a model for each type of transaction. Each type of transaction is identified and the CPU utilization for the transaction is determined. This utilization can be measured in MIPS or in time. For each transaction, the start time of the transaction and the CPU time for the transactions are used to determine the overall transaction per second and the CPU percentage consumed for each type of transaction. The resource consumption for each type of transaction is used to build a model for each type of transaction. In one embodiment the model is a model of the MIPS consumed by each type of transaction versus the CPU utilization for each type of transaction. To generate the model the transaction model builder uses a machine learning algorithm with the transaction data to train and create the transaction model. In some embodiments the model is a linear regression model. However, other types of models can be used such as support vector machines, decision trees, Bayesian networks, etc. A transaction model for each type of transaction is then output for later use.

A new base workload based on the transactions within that workload is built when the characteristics of the workload are changed. This is illustrated at step 340. In some embodiments the workload construct module 140 obtains transaction parameters. If the parameters have changed, a random percentage of the transactions per second. The number of MIPS consumed for each workload is determined. a relative workload consumption of the particular workload as against the highest priority workloads is determined. The CPU utilization for each workload is determined and output as a set of new models for the workloads.

The estimated response time for the workloads is then calculated. This is illustrated at step 350. In some embodiments this is done by the resource estimation module. The new models are obtained and the number of CPUs in the hardware and the MIPS for the system are determined. Using this information an impact factor and a low impact factor is calculated for each workload. The estimated response time is calculated based on the low impact factor and the service time.

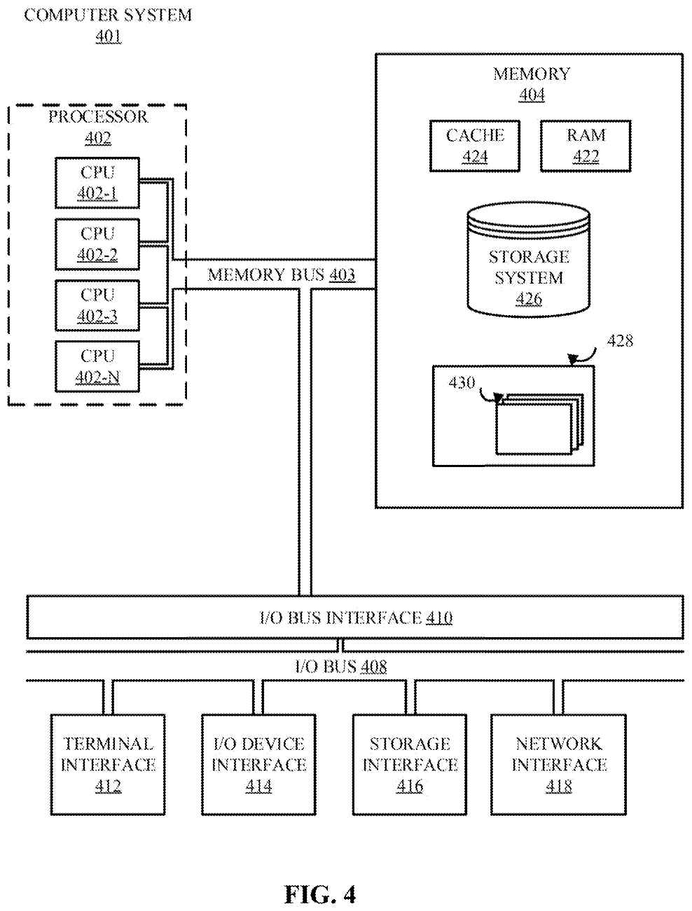

Referring now to FIG. 4, shown is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smart phone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

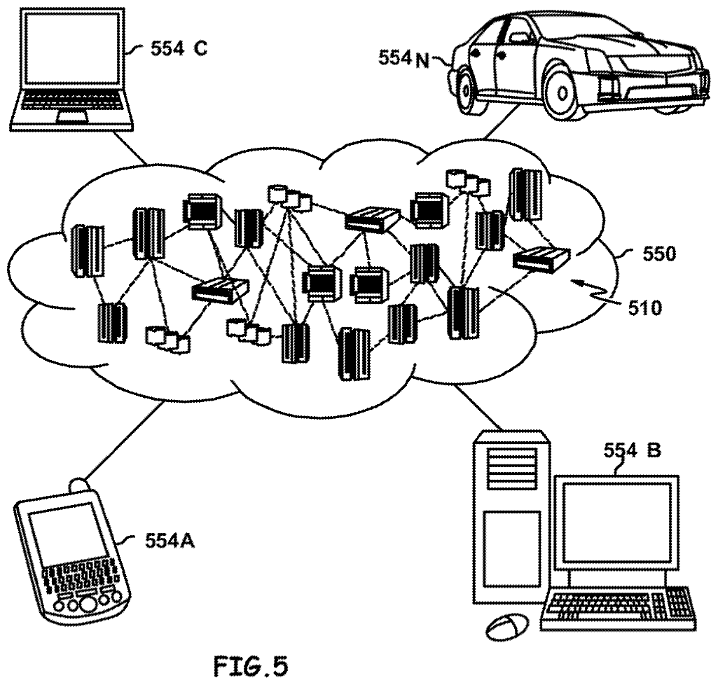

The system 100 can be employed in a cloud computing environment. FIG. 5, is a diagrammatic representation of an illustrative cloud computing environment 550 according to one embodiment. As shown, cloud computing environment 550 comprises one or more cloud computing nodes 510 with which local computing devices used by cloud consumers, such as, for example, personal digital assistant (PDA) or cellular telephone 554A, desktop computer 554B, laptop computer 554C, and/or automobile computer system 554N may communicate. Nodes 510 may communicate with one another. They may be grouped (not shown) physically or virtually, in one or more networks, such as Private, Community, Public, or Hybrid clouds as described hereinabove, or a combination thereof. This allows cloud computing environment 550 to offer infrastructure, platforms and/or software as services for which a cloud consumer does not need to maintain resources on a local computing device. It is understood that the types of computing devices 554A-N shown in FIG. 5 are intended to be illustrative only and that computing nodes 10 and cloud computing environment 550 may communicate with any type of computerized device over any type of network and/or network addressable connection (e.g., using a web browser).

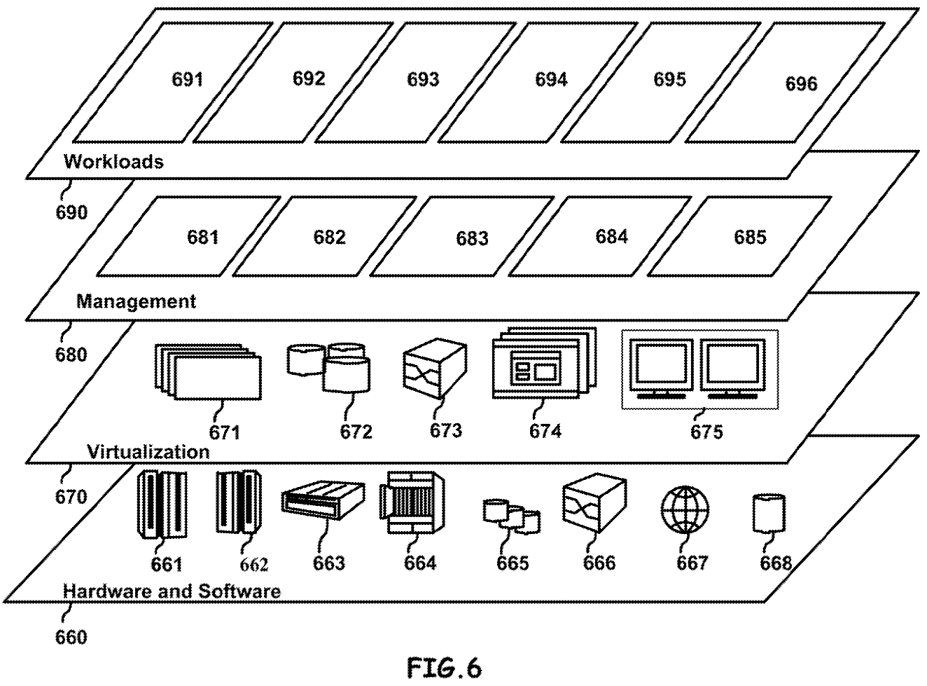

Referring now to FIG. 6, a set of functional abstraction layers provided by cloud computing environment 550 (FIG. 5) is shown. It should be understood in advance that the components, layers, and functions shown in FIG. 6 are intended to be illustrative only and embodiments of the disclosure are not limited thereto. As depicted, the following layers and corresponding functions are provided:

Hardware and software layer 660 includes hardware and software components. Examples of hardware components include: mainframes 661; RISC (Reduced Instruction Set Computer) architecture based servers 662; servers 663; blade servers 664; storage devices 665; and networks and networking components 666. In some embodiments, software components include network application server software 667 and database software 668.

Virtualization layer 670 provides an abstraction layer from which the following examples of virtual entities may be provided: virtual servers 671; virtual storage 672; virtual networks 673, including virtual private networks; virtual applications and operating systems 674; and virtual clients 675.

In one example, management layer 680 may provide the functions described below. Resource provisioning 681 provides dynamic procurement of computing resources and other resources that are utilized to perform tasks within the cloud computing environment. Metering and Pricing 682 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 683 provides access to the cloud computing environment for consumers and system administrators. Service level management 684 provides cloud computing resource allocation and management such that required service levels are met. Service Level Agreement (SLA) planning and fulfillment 685 provide pre-arrangement for, and procurement of, cloud computing resources for which a future requirement is anticipated in accordance with an SLA.

Workloads layer 690 provides examples of functionality for which the cloud computing environment may be utilized. Examples of workloads and functions which may be provided from this layer include: mapping and navigation 691; software development and lifecycle management 692; virtual classroom education delivery 693; data analytics processing 694; transaction processing 695; and database 696.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A system for predicting hardware upgrade impacts due to variables in configurations, comprising:
a data collection module configured to collect data from the system prior to a hardware upgrade;
a workload analysis module configured to analyze the data and build a workload model to determine a relationship between different types of workloads processed through the system;
a transaction analysis module configured to analyze a resource consumption of transactions within each workload;
a workload construct module configured to construct a new utilization model based on transactions within that workload based on changes to transactions within the workload; and
a response time estimation module configured to take input from a user and determine a response time based on CPU utilization.

2. The system of claim 1 wherein the workload analysis module further comprises:
a workload identification module configured to identify a priority for each of the workloads and an associated CPU usage; and
a workload model builder configured to generate at least one workload relationship model for each workload.

3. The system of claim 2 wherein the workload identification module is configured to divide the workloads into a plurality of priority classes.

4. The system of claim 3 wherein the workload identification module is configured to determine CPU usage for each of the plurality of priority classes.

5. The system of claim 2 wherein the workload model builder is configured receive from the workload identification module a plurality of priority classes and CPU usage for the plurality of priority classes, and apply machine learning to generate at least one workload relationship model for each of the plurality of priority classes.

6. The system of claim 5 wherein the workload model builder is configured to output the at least one model for each of the plurality of priority classes wherein each model represents a relationship between the priority class as against other priority classes that have a higher priority value.

7. The system of claim 1 wherein the workload construct model is configured to receive an indication that a proportion of the workload has changed.

8. The system of claim 1 wherein the workload construct module is configured to:
generate a random list of transactions and associated transactions per second for the workload;
determine a number of millions of instructions per second for the workload;
determine a relative workload consumption for the workload as against a highest priority workload;
determine CPU utilization for the workload; and
create the new utilization model for each priority level of workloads.

9. The system of claim 1 wherein the response time estimation module is configured to calculate an impact factor for a particular workload based on CPU utilization within the new utilization model for a priority level associated with the particular workload.

10. The system of claim 9 wherein the response time estimation module is configured to calculate a low impact factor for the particular workload based upon the impact factor for the particular workload, a sum of workload priorities that are higher than the priority level associated with the particular workload, and a lowest workload priority.

11. The system of claim 10 wherein the response time for the priority level associated with the particular workload is calculated by adding 1 to the low impact factor and multiplying by a service time.

12. A method of predicting a response time for a workload prior to making a hardware upgrade to a system, comprising:
collecting data related to operation of the system;
building a workload model of a plurality of workloads and CPU utilization for the plurality of workloads;
building a transaction model for each transaction within a workload of the plurality of workloads;
determining that a characteristic of at least one workload in the plurality of workloads will change due to the hardware upgrade;
building a new workload model for the at least one workload based on the changed characteristic; and
determining the response time for the workload based on the new workload model.

13. The method of claim 12 wherein building the workload model further comprises:
determining a relationship between workloads based on a priority classes of the plurality of workloads; and
determining CPU utilization for the priority classes.

14. The method of claim 13 further comprising:
identifying a priority class for each of the plurality of workloads.

15. The method of claim 12 wherein building the transaction model further comprises:
determining a number of transactions per second for each type of transaction; and
determining a CPU percentage for each type of transaction.

16. The method of claim 12 wherein building the new workload model further comprises:
generating a random list of transactions and associated transactions per second for the workload;
determining a number of millions of instructions per second for the workload;
determining a relative workload consumption for the workload as against a highest priority workload;
determining CPU utilization for the workload; and
creating the new utilization model for each priority level of workloads.

17. The method of claim 12 wherein determining the response time further comprises:
determining an impact factor for the at least one workload according to
$$\frac{Q}{S} = \frac{\frac{{u}^{C}}{\text{?}}}{\frac{{u}^{C}}{\text{?}} + ( 1 - U ) \times \text{?} \frac{\text{?}}{n !}} \times \frac{1}{C \times ( 1 - U )}$$
$$\text{?} \text{indicates text missing or illegible when filed}$$
where Ft is the impact factor;
c is the number of CPU's present;
u is the CPU utilization rate based on the new workload model;
Q is the queuing time;
S is the service time; and
U is the workload priority for the at least one workload.

18. The method of claim 17 further comprising:
determining a low impact factor for the at least one workload according to;
$$FtLow ( c , u ) = \frac{U}{Ul} * Ft ( c , u ) - \frac{Uh}{Ul} * Ft ( c , u )$$
where Ul us a lowest priority workload and Uh is a sum of the workloads that are higher priority than the at least one workload's priority U.

19. The method of claim 18 wherein the response time is calculated by:
ResptPrio(c,u)=(1+FtLow(c,u)*S
where ResptPrio(c,u) is the response time for the at least one workload.

20. A computer program product embodied on a computer readable storage medium having computer readable instructions that when executed by a computer cause the computer to execute instructions for predicating a response time for a workload prior to making a hardware upgrade to a system, comprising instructions to:
collect data related to operation of the system;
build a workload model of a plurality of workloads and CPU utilization for the plurality of workloads;
build a transaction model for each transaction within a workload of the plurality of workloads;
determine that a characteristic of at least one workload in the plurality of workloads will change due to the hardware upgrade;
build a new workload model for the at least one workload based on the changed characteristic; and
determine the response time for the workload based on the new workload model.
